(19) United States
(12) Patent Application Publication
(10) Pub. No.: US 2026/0267070 A1
(43) Pub. Date: Sep. 10, 2026

(54) COATING REMOVER

(71) Applicant: SUMITOMO ELECTRIC OPTIFRONTIER CO., LTD., Kanagawa (JP)

(72) Inventors: Yuta RYONO, Kanagawa (JP); Hiroshi NAKAMURA, Kanagawa (JP); Atsushi KUWAHARA, Kanagawa (JP); Ryuichiro SATO, Kanagawa (JP)

(21) Appl. No.: 19/167,417

(22) PCT Filed: Jun. 4, 2024
(86) PCT No.: PCT/JP2024/020303

§ 371 Date: Sep. 22, 2025

(30) Foreign Application Priority Data
Apr. 5, 2023 (JP) 2023-061741

(51) Int. Cl. G02B 6/245; H02G 1/12

(52) U.S. Cl. CPC G02B 6/245; H02G 1/1204

(57) ABSTRACT

In a coating remover according to one embodiment, an optical fiber placement portion has a hole recessed in a first direction or a protrusion protruding in a second direction that is a direction opposite to the first direction. The lid portion has a protrusion that enters the hole of the optical fiber placement portion when the second blade comes into contact with the coating or a hole that the protrusion of the optical fiber placement portion enters when the second blade comes into contact with the coating. The protrusion of the optical fiber placement portion or the protrusion of the lid portion is formed by the plurality of surfaces. Among the plurality of surfaces, a first surface that is a surface facing away from the first blade and the second blade extends along the first direction.

### TECHNICAL FIELD

The present disclosure relates to a coating remover.

Priority is claimed on Japanese Patent Application No. 2023-061741, filed on Apr. 5, 2023, the entire content of which is incorporated herein by reference.

### BACKGROUND ART

Patent Literature 1 describes a stripping device. The stripping device includes a first base including a first blade body and a second base including a second blade body. The first blade body has a first abutment surface protruding beyond the first base. The second blade body has a second abutment surface protruding beyond the second base body. In a state where the first abutment surface is in contact with the second abutment surface, the distance between the cutting edge of the first blade body and the cutting edge of the second blade body is an optimal distance for stripping an optical fiber core.

Patent Literature 2 describes an optical fiber coating removal device. The optical fiber coating removal device includes a pair of bases and a pair of cutters fixed to the pair of respective bases. The cutter includes a blade that cuts into a coating of an optical fiber; a protruding portion having a step shape that protrudes from the blade; and a cutout portion formed on the side opposite to the blade. In the pair of cutters, the distance between a pair of the blades can be changed by changing abutting portions of a pair of the protruding portions.

Patent Literature 3 describes a coating remover. The coating remover includes an adjustment jig for adjusting the distance between a first blade portion and a second blade portion. The adjustment jig includes a main body portion; a movable portion provided to be movable relative to the main body portion; and a spacer portion provided on the movable portion. The spacer portion moves in conjunction with the operation of the movable portion. The spacer portion moves between a first position located between the first blade portion and the second blade portion and a second position other than the first position.

Patent Literature 4 and Patent Literature 5 describes an optical fiber coating remover. The optical fiber coating remover includes a main body including a lid; a slide portion including a lid; a blade portion; and a heating portion. In a state where the lid of the main body and the lid of the slide portion are opened, a fiber holder that grips an optical fiber core including a coating end portion is disposed in the slide portion. After the fiber holder is disposed in the slide portion and the lid of the main body and the lid of the slide portion are closed, the heating portion heats and softens the coating end portion. At this time, the blade portion cuts into only the coating of the optical fiber core. Then, the coating is removed from the optical fiber core by holding the main body with one hand and the slide portion with the other hand and pulling the slide portion away from the main body.

### CITATION LIST

### Patent Literature

Patent Literature 1: Japanese Unexamined Patent Publication No. H5-224025
Patent Literature 2: Japanese Unexamined Patent Publication No. 2003-143727
Patent Literature 3: Japanese Unexamined Patent Publication No. 2015-184647
Patent Literature 4: Japanese Design Registration No. 1359572
Patent Literature 5: Japanese Design Registration No. 1397556

### SUMMARY OF INVENTION

A coating remover according to the present disclosure includes an optical fiber placement portion on which an optical fiber core including a coating is placed, and which includes a first blade that cuts into the coating; and a lid portion openable and closable relative to the optical fiber placement portion and including a second blade that faces the first blade along a first direction, which is a closing direction, when the lid portion is closed onto the optical fiber placement portion. The optical fiber placement portion has a hole recessed in the first direction or a protrusion protruding in a second direction that is a direction opposite to the first direction. The lid portion has a protrusion that enters the hole of the optical fiber placement portion when the second blade comes into contact with the coating or a hole that the protrusion of the optical fiber placement portion enters when the second blade comes into contact with the coating. The protrusion of the optical fiber placement portion or the protrusion of the lid portion is formed by a plurality of surfaces. Among the plurality of surfaces, a first surface that is a surface facing away from the first blade and the second blade extends along the first direction.

### BRIEF DESCRIPTION OF DRAWINGS

FIG. 1 is a perspective view showing a coating remover according to one embodiment.

FIG. 2 is a perspective view showing a state where an optical fiber holder is disposed in a holder holding portion of the coating remover of FIG. 1.

FIG. 3 is a perspective view showing the holder holding portion and a main body portion of the coating remover of FIG. 1.

FIG. 4 is a perspective view showing a hole formed in an optical fiber placement portion and a protrusion formed on a lid portion in the main body portion of FIG. 3.

FIG. 5 is a cross-sectional view of the hole and the protrusion of FIG. 4 taken along a plane perpendicular to a direction in which an optical fiber core extends.

FIG. 6 is a cross-sectional view of the coating remover of FIG. 1 taken along a plane extending along the direction in which the optical fiber core extends.

FIG. 7 is an enlarged cross-sectional view of the hole and the protrusion of the coating remover of FIG. 6.

### DESCRIPTION OF EMBODIMENTS

### Technical Problem

The coating remover includes an optical fiber placement portion on which an optical fiber core is placed, and a lid portion that is openable and closable relative to the optical fiber placement portion. Each of the optical fiber placement portion and the lid portion includes a blade that cuts into a coating of the optical fiber core. By the way, the position of the blade of the lid portion in a direction in which the optical fiber core extends may be shifted from the position of the blade of the optical fiber placement portion in the direction in which the optical fiber core extends. When the position of the blade of the lid portion is shifted from the position of the blade of the optical fiber placement portion, there is a possibility that a force is not applied evenly to the coating, thereby causing a change in the posture of the optical fiber core and leading to breakage. Therefore, it is required that the position of the blade of the lid portion in the extending direction of the optical fiber core is not shifted from the position of the blade of the optical fiber placement portion.

### Advantageous Effects of Invention

According to the present disclosure, the position of the blade can be prevented from being shifted.

### Description of Embodiment of Present Disclosure

An embodiment of the present disclosure will be listed and described. A coating remover according to one embodiment includes (1) an optical fiber placement portion on which an optical fiber core including a coating is placed, and which includes a first blade that cuts into the coating; and a lid portion openable and closable relative to the optical fiber placement portion and including a second blade that faces the first blade along a first direction, which is a closing direction, when the lid portion is closed onto the optical fiber placement portion. The optical fiber placement portion has a hole recessed in the first direction or a protrusion protruding in a second direction that is a direction opposite to the first direction. The lid portion has a protrusion that enters the hole of the optical fiber placement portion when the second blade comes into contact with the coating or a hole that the protrusion of the optical fiber placement portion enters when the second blade comes into contact with the coating. The protrusion of the optical fiber placement portion or the protrusion of the lid portion is formed by a plurality of surfaces. Among the plurality of surfaces, a first surface that is a surface facing away from the first blade and the second blade extends along the first direction.

The coating remover includes the optical fiber placement portion on which the optical fiber core is placed, and the lid portion that is openable and closable relative to the optical fiber placement portion. The optical fiber placement portion includes the first blade that cuts into the coating of the optical fiber core, and the lid portion includes the second blade facing the first blade along the first direction that is a closing direction. The optical fiber placement portion has a hole recessed in the first direction or a protrusion protruding in the second direction that is a direction opposite to the first direction. The lid portion has a protrusion that enters the hole of the optical fiber placement portion when the second blade comes into contact with the coating or a hole that the protrusion of the optical fiber placement portion enters when the second blade comes into contact with the coating. The protrusion of the optical fiber placement portion or the protrusion of the lid portion is formed by the plurality of surfaces. Among the plurality of surfaces, the first surface that is a surface facing away from the first blade and the second blade extends along the first direction. The first surface extends along the first direction that is a direction in which the second blade of the lid portion faces the first blade. When the second blade comes into contact with the coating and the protrusion enters the hole, the first surface of the protrusion which extends along the first direction faces an inner surface of the hole along an extending direction of the optical fiber core. Since the first surface of the protrusion faces the inner surface of the hole along the extending direction of the optical fiber core, the misalignment of the second blade in the extending direction is prevented by the first surface of the protrusion. Therefore, the position of the second blade of the lid portion in the extending direction can be prevented from being shifted from the first blade of the optical fiber placement portion.

(2) In (1) above, among the plurality of surfaces, a second surface facing away from the first surface may extend along the first direction. In this case, when the second blade comes into contact with the coating and the protrusion enters the hole, the second surface of the protrusion which extends along the first direction faces the inner surface of the hole along the extending direction of the optical fiber core. Since the misalignment of the second blade in the extending direction is prevented by the second surface of the protrusion, the position of the second blade of the lid portion in the extending direction can be prevented from being shifted from the first blade of the optical fiber placement portion.

(3) In (1) or (2) above, the optical fiber placement portion may have a hole recessed in the first direction, and the lid portion may have a protrusion that enters the hole. In this case, since the hole is formed in the optical fiber placement portion located below the lid portion, even when debris of the optical fiber core enters the hole, the debris can be easily removed.

(4) In (3) above, the hole may be open in a third direction that is a direction intersecting both the first direction and the second direction. In this case, since the hole of the optical fiber placement portion is open in the third direction, debris of the optical fiber core can be removed more easily.

A coating remover according to another embodiment includes (5) an optical fiber placement portion on which an optical fiber core including a coating is placed, and which includes a first blade that cuts into the coating; and a lid portion openable and closable relative to the optical fiber placement portion and including a second blade that faces the first blade along a first direction, which is a closing direction, when the lid portion is closed onto the optical fiber placement portion. The optical fiber placement portion has a hole recessed in the first direction or a protrusion protruding in a second direction that is a direction opposite to the first direction. The lid portion has a protrusion that enters the hole of the optical fiber placement portion or a hole that the protrusion of the optical fiber placement portion enters. The protrusion of the optical fiber placement portion or the protrusion of the lid portion enters the hole of the lid portion or the hole of the optical fiber placement portion before the second blade of the lid portion comes into contact with the coating of the optical fiber core placed on the optical fiber placement portion.

In the coating remover, the optical fiber placement portion includes the first blade that cuts into the coating of the optical fiber core, and the lid portion includes the second blade facing the first blade along the first direction. The optical fiber placement portion has a hole recessed in the first direction or a protrusion protruding in the second direction that is a direction opposite to the first direction. The lid portion has a protrusion that enters the hole of the optical fiber placement portion or a hole that the protrusion of the optical fiber placement portion enters. The protrusion of the optical fiber placement portion or the protrusion of the lid portion enters the hole of the lid portion or the hole of the optical fiber placement portion before the second blade of the lid portion comes into contact with the coating of the optical fiber core placed on the optical fiber placement portion. Before the second blade comes into contact with the coating, the protrusion enters the hole. When the protrusion enters the hole, a surface of the protrusion faces an inner surface of the hole along an extending direction of the optical fiber core. Since the surface of the protrusion faces the inner surface of the hole along the extending direction of the optical fiber core, the misalignment of the second blade in the extending direction is prevented by the surface of the protrusion. Therefore, the position of the second blade of the lid portion in the extending direction can be prevented from being shifted from the first blade of the optical fiber placement portion.

### Details of Embodiment of Present Disclosure

A specific example of a coating remover according to an embodiment of the present disclosure will be described below with reference to the drawings. The present invention is not limited to the example, but is set forth by the claims, and is intended to include all modifications within the claims and their equivalents. In the description of the drawings, the same or corresponding elements are denoted by the same reference signs, and duplicate descriptions will be omitted as appropriate. The drawings may be partially depicted in a simplified or exaggerated manner for ease of understanding, and dimensional ratios and the like are not limited to those shown in the drawings.

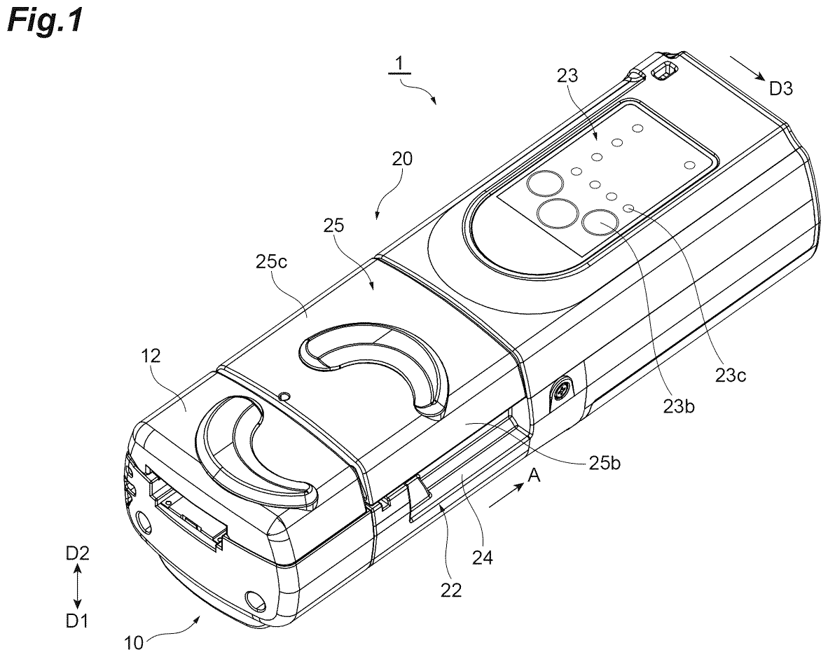

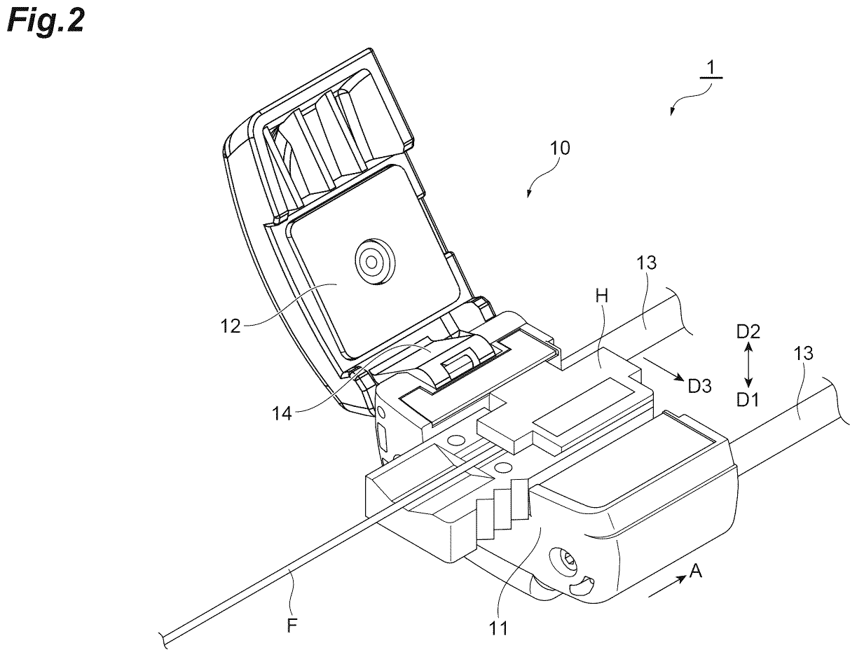

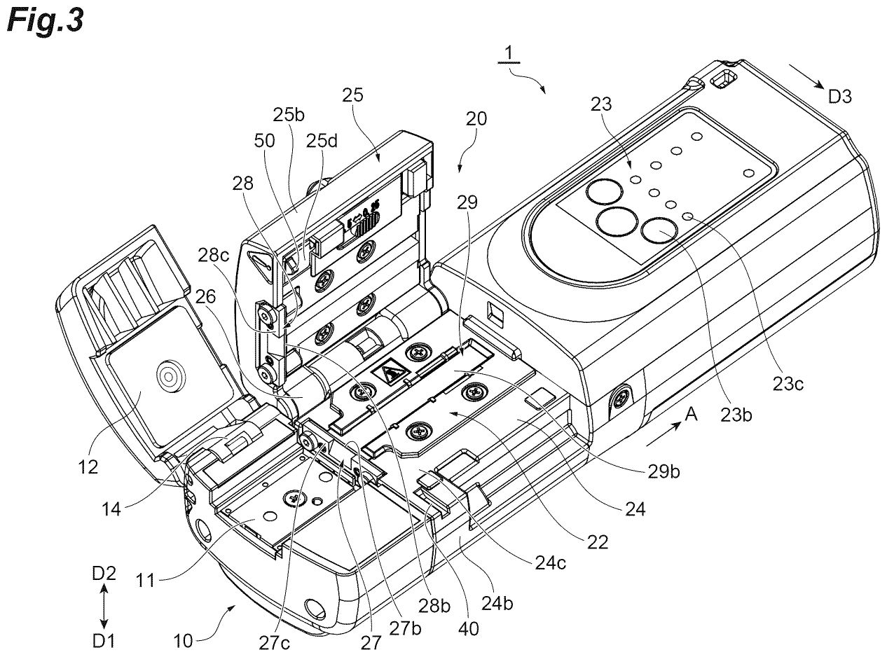

FIG. 1 is a perspective view showing a coating remover 1 according to one embodiment. FIG. 2 is a perspective view showing the coating remover 1 on which an optical fiber holder H that holds an optical fiber core F on which the coating remover 1 performs coating removal is placed. FIG. 3 is a perspective view showing an internal structure of the coating remover 1 shown in FIG. 1. The optical fiber core F includes, for example, a glass fiber and a resin coating that covers the glass fiber. The coating remover 1 is a device that removes the coating from the optical fiber core F. A diameter of the optical fiber core F (outer diameter of the coating of the optical fiber core F) is, for example, 180 μm or more and 400 μm or less.

For example, the coating remover 1 includes a holder holding portion 10 and a main body portion 20. The holder holding portion 10 includes a holder placement portion 11 on which the optical fiber holder H that holds the optical fiber core F is placed, and a lid portion 12 that is openable and closable relative to the holder placement portion 11. The optical fiber holder H holds an end portion of the optical fiber core F. The length of a portion of the optical fiber core F from which the coating is removed is adjusted by adjusting the position where the optical fiber holder H holds the optical fiber core F. In the following description, a direction in which the lid portion 12 is closed onto the holder placement portion 11 is referred to as a first direction D1, and a direction in which the lid portion 12 is opened from the holder placement portion 11 is referred to as a second direction D2. For example, the coating remover 1 extends in an extending direction A that is a direction in which the optical fiber core F extends, and has a width in a third direction D3 that is a direction intersecting both the first direction D1 and the second direction D2.

The holder holding portion 10 and the main body portion 20 are aligned along the extending direction A. The main body portion 20 is connected to an end portion of the holder holding portion 10 in the extending direction A. The holder holding portion 10 includes a slide shaft 13 extending to the main body portion 20. The holder holding portion 10 includes two slide shafts 13, and the two slide shafts 13 are aligned along the third direction D3. The main body portion 20 has sliding holes into which the slide shafts 13 are inserted. The main body portion 20 has two sliding holes, and the two sliding holes are aligned along the third direction D3. The slide shafts 13 are slidably inserted into the sliding holes formed in the main body portion 20. The holder holding portion 10 is slidable in a direction toward the main body portion 20 and in a direction away from the main body portion 20. Hereinafter, the direction in which the holder holding portion 10 becomes spaced apart from the main body portion 20 may be referred to as the front, forward, or front side, and the direction in which the holder holding portion 10 approaches the main body portion 20 may be referred to as the rear, rearward, or rear side.

The holder holding portion 10 holds the optical fiber holder H that holds the optical fiber core F. The holder holding portion 10 includes a hinge 14 that allows the lid portion 12 to be opened and closed relative to the holder placement portion 11. The hinge 14 extends along the extending direction A at an end portion of the holder holding portion 10 opposite to the third direction D3. The lid portion 12 is openable and closable relative to the holder placement portion 11 by rotating the lid portion 12 about the hinge 14. The holder holding portion 10 holds the optical fiber holder H placed on the holder placement portion 11 by sandwiching the optical fiber holder H between the holder placement portion 11 and the lid portion 12.

The main body portion 20 includes a coating removal portion 22 that is portion for removing the coating from the optical fiber core F, and an operation portion 23 for operating the coating removal by the coating removal portion 22. The coating removal portion 22 and the operation portion 23 are aligned along the extending direction A. The coating removal portion 22 is located between the operation portion 23 and the holder holding portion 10. The coating removal portion 22 includes an optical fiber placement portion 24 on which the optical fiber core F is placed, and a lid portion 25 that is openable and closable relative to the optical fiber placement portion 24. The lid portion 25 is closed onto the optical fiber placement portion 24 by moving in the first direction D1. The lid portion 25 is opened from the optical fiber placement portion 24 by moving in the second direction D2.

The coating removal portion 22 includes a hinge 26 that allows the lid portion 25 to be opened and closed relative to the optical fiber placement portion 24. The hinge 26 extends along the extending direction A at an end portion of the main body portion 20 opposite to the third direction D3. The lid portion 25 is openable and closable relative to the optical fiber placement portion 24 by rotating the lid portion 25 about the hinge 26. The main body portion 20 holds the optical fiber core F placed on the optical fiber placement portion 24 by sandwiching the optical fiber core F between the optical fiber placement portion 24 and the lid portion 25.

For example, the optical fiber placement portion 24 includes a side surface portion 24b facing the third direction D3 and a top surface portion 24c facing the lid portion 25 that is closed. The optical fiber placement portion 24 includes a first blade 27 that cuts into the coating of the optical fiber core F. The first blade 27 is disposed on the front side of the optical fiber placement portion 24. The first blade 27 includes, for example, a first blade portion 27b that cuts into the coating, and a support portion 27c that supports the first blade portion 27b. The first blade portion 27b and the support portion 27c are made of, for example, metal. The first blade portion 27b and the support portion 27c are integrally formed.

For example, the lid portion 25 includes a side surface portion 25b facing the third direction D3 when closed; a top surface portion 25c facing the second direction D2 when closed; and an inner surface portion 25d facing the top surface portion 24c of the optical fiber placement portion 24 when closed. The lid portion 25 includes a second blade 28 that cuts into the coating of the optical fiber core F. The second blade 28 is disposed on the front side of the lid portion 25. The second blade 28 is disposed at a position where the second blade 28 faces the first blade 27 along the first direction D1 when the lid portion 25 is closed onto the optical fiber placement portion 24. The second blade 28 includes a second blade portion 28b that cuts into the coating, and a support portion 28c that supports the second blade portion 28b. The second blade portion 28b and the support portion 28c are made of, for example, metal. The second blade portion 28b and the support portion 28c are integrally formed.

The first blade 27 and the second blade 28 face each other along the first direction DI when the lid portion 25 is closed onto the optical fiber placement portion 24. A cut is made in the coating of the optical fiber core F located between the first blade portion 27b and the second blade portion 28b. The distance between the first blade portion 27b and the second blade portion 28b is set such that the first blade portion 27b and the second blade portion 28b come into contact with the coating of the optical fiber core F, but the first blade portion 27b and the second blade portion 28b do not come into contact with the glass fiber of the optical fiber core F.

The optical fiber placement portion 24 includes a heating portion 29. The heating portion 29 is disposed behind the first blade 27. The heating portion 29 includes a heater 29b. The heater 29b receives a supply of electric power, and heats the coating of the optical fiber core F. The supply of electric power to the heater 29b is controlled by a heater power switch (not shown) that turns on when the lid portion 25 is closed onto the optical fiber placement portion 24 and turns off when the lid portion 25 is opened from the optical fiber placement portion 24. The heater 29b performs heating when the lid portion 25 is closed onto the optical fiber placement portion 24.

The operation portion 23 is disposed behind the coating removal portion 22. The operation portion 23 includes a switch 23b for turning a power source on and off or regulating the temperature of the heater 29b and a display portion 23c indicating the state of the heater 29b (for example, the heating temperature and the on/off state of the heater 29b). The display portion 23c displays, for example, that the optical fiber core F is heated by the heater 29b and the temperature of the optical fiber core F has reached a maximum temperature for removing the coating. For example, a battery (not shown) that supplies electric power to the heater 29b is built into the operation portion 23.

For example, the hinge 26 that allows the lid portion 25 to be opened and closed relative to the optical fiber placement portion 24 is a molded article. In this case, a clearance may occur in the hinge 26 due to the influence of the draft angle. When a clearance occurs in the hinge 26, there is a possibility that the position of the second blade 28 of the lid portion 25 in the extending direction A is shifted from the position of the first blade 27 of the optical fiber placement portion 24 in the extending direction A. When the position of the second blade 28 of the lid portion 25 is shifted from the position of the first blade 27 of the optical fiber placement portion 24, breakage occurs due to a force not being applied evenly to the coating of the optical fiber core F, which is a risk. The coating remover 1 according to the present embodiment has a hole 40 and a protrusion 50 that enters the hole 40, so that the misalignment of the second blade 28 relative to the first blade 27 is prevented. Hereinafter, the hole 40 and the protrusion 50 will be described in detail.

The optical fiber placement portion 24 has the hole 40 recessed in the first direction D1. The lid portion 25 has the protrusion 50 that enters the hole 40 of the optical fiber placement portion 24 when the lid portion 25 is closed and the second blade 28 comes into contact with the coating of the optical fiber core F. The protrusion 50 enters the hole 40 before the second blade 28 of the lid portion 25 comes into contact with the coating of the optical fiber core F placed on the optical fiber placement portion 24. The entry of the protrusion 50 into the hole 40 restricts movement of the lid portion 25 in the extending direction A relative to the optical fiber placement portion 24.

The hole 40 is formed in the top surface portion 24c of the optical fiber placement portion 24. The hole 40 is formed at a position behind the first blade 27 and spaced apart from the hinge 26. When viewed along the extending direction A, the first blade 27 is disposed between the hinge 26 and the hole 40. The hole 40 extends along the third direction D3. The protrusion 50 is formed on the inner surface portion 25d of the lid portion 25. The protrusion 50 is formed at a position behind the second blade 28 and spaced apart from the hinge 26. When viewed along the extending direction A, the second blade 28 is disposed between the hinge 26 and the protrusion 50.

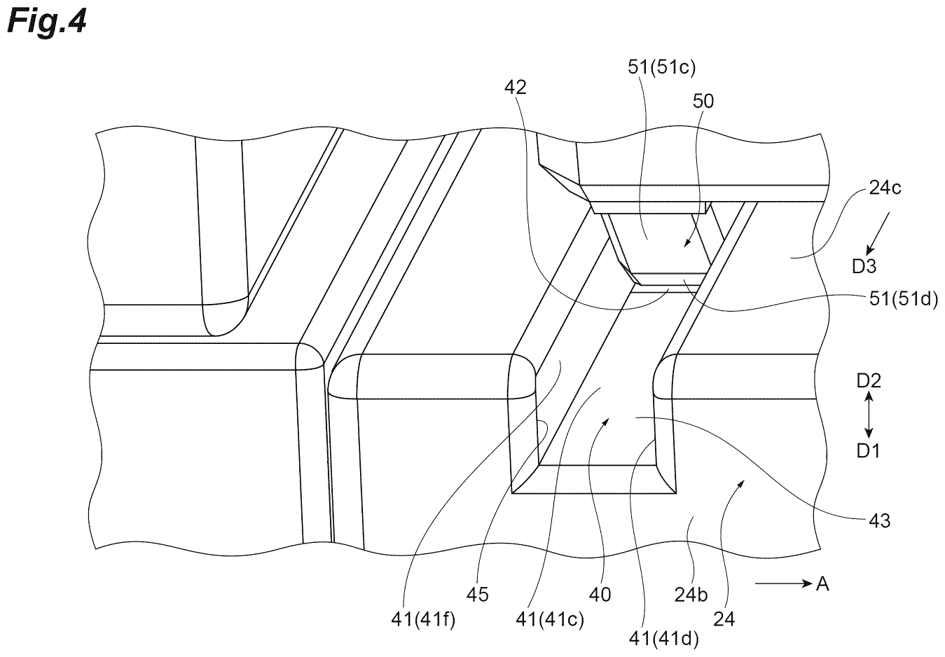

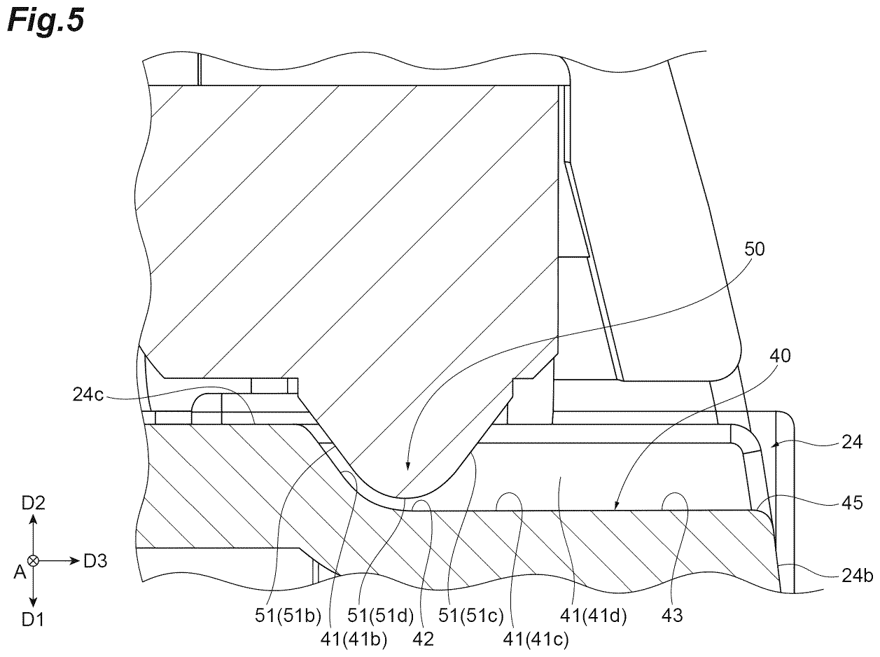

FIG. 4 is an enlarged perspective view of the hole 40 and the protrusion 50. FIG. 5 is a cross-sectional view of the hole 40 and the protrusion 50 taken along a plane perpendicular to the extending direction A. As shown in FIGS. 4 and 5, the hole 40 is open in the third direction D3. The hole 40 has an opening 45 formed in the side surface portion 24b of the optical fiber placement portion 24. The hole 40 is defined by a plurality of surfaces 41. For example, the plurality of surfaces 41 are defined by an inclined surface 41b that is inclined obliquely downward from the top surface portion 24c of the optical fiber placement portion 24, a bottom surface 41c extending from a lower end of the inclined surface 41b along the third direction D3, a first inner surface 41d extending in the second direction D2 from an end portion of the bottom surface 41c in the extending direction A, and a second inner surface 41f facing the first inner surface 41d along the extending direction A.

For example, the inclined surface 41b has a curved shape conforming to the shape of the protrusion 50. The bottom surface 41c, the first inner surface 41d, and the second inner surface 41f have a planar shape. The bottom surface 41c extends in both the extending direction A and the third direction D3. Each of the first inner surface 41d and the second inner surface 41f extends in both the first direction D1 and the third direction D3. For example, the hole 40 includes a protrusion accommodating portion 42 that the protrusion 50 enters, and an extending portion 43 extending from the protrusion accommodating portion 42 along the third direction D3. The protrusion accommodating portion 42 is defined by the inclined surface 41b, the bottom surface 41c, the first inner surface 41d, and the second inner surface 41f. The extending portion 43 is defined by the bottom surface 41c, the first inner surface 41d, and the second inner surface 41f. The extending portion 43 reaches the side surface portion 24b of the optical fiber placement portion 24. A portion of the extending portion 43 that has reached the side surface portion 24b serves as the opening 45.

The protrusion 50 is defined by a plurality of surfaces 51. The plurality of surfaces 51 include a first inclined surface 51b extending obliquely relative to both the first direction D1 and the third direction D3; a second inclined surface 51c extending obliquely downward and in a direction toward the first inclined surface 51b; and a curved surface 51d that connects the first inclined surface 51b and the second inclined surface 51c to each other. The first inclined surface 51b extends along the inclined surface 41b of the hole 40. The second inclined surface 51c extends obliquely downward from an end portion of the protrusion 50 opposite to the first inclined surface 51b. For example, when viewed along the extending direction A, the protrusion 50 has an inverted triangular shape with a downward-facing corner rounded.

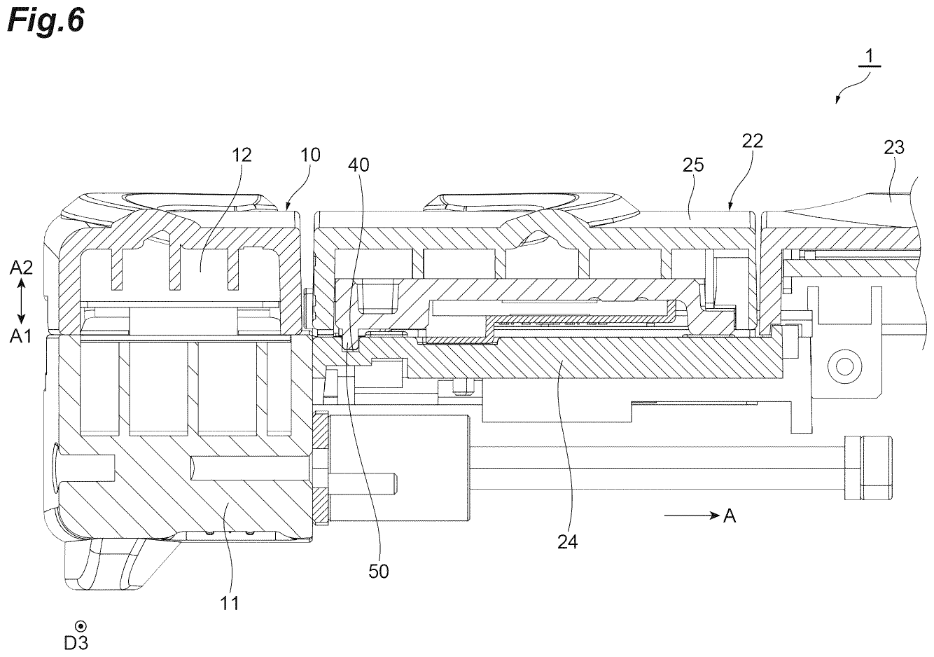

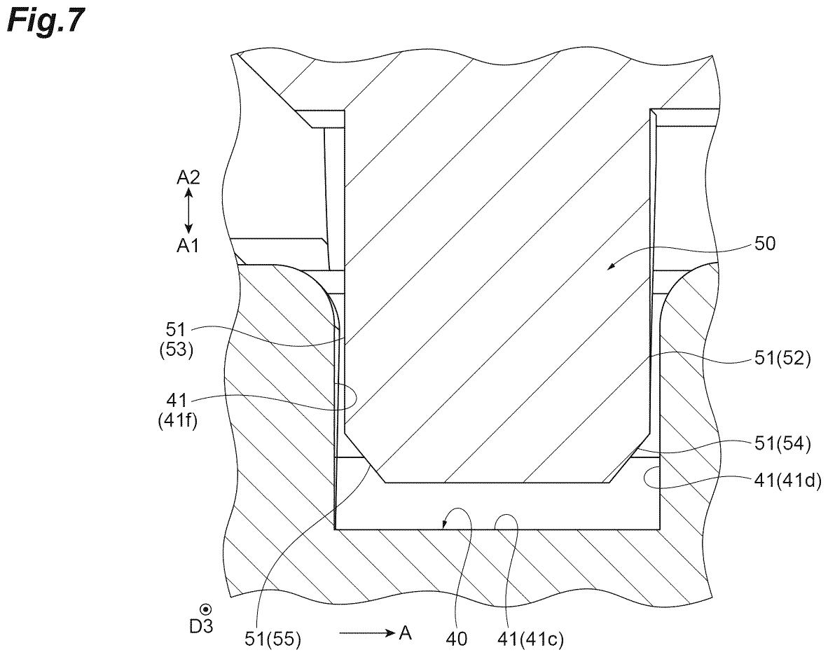

FIG. 6 is a cross-sectional view of the coating remover 1 taken along a plane extending in both the extending direction A and the first direction D1. FIG. 7 is an enlarged cross-sectional view of the hole 40 and the protrusion 50 of the coating remover 1 of FIG. 6. As shown in FIGS. 6 and 7, the cross-section of the protrusion 50 taken along a plane extending in both the extending direction A and the first direction D1 has a rectangular shape. The plurality of surfaces 51 of the protrusion 50 include a first surface 52 facing away from the first blade 27 and the second blade 28 and a second surface 53 facing away the first surface 52.

For example, the first surface 52 has a planar shape. The first surface 52 extend along the first direction D1. The first surface 52 is perpendicular to, for example, the extending direction A. The first surface 52 extends in both the first direction D1 and the third direction D3. The first surface 52 faces the first inner surface 41d of the hole 40 along the extending direction A when the protrusion 50 enters the hole 40.

For example, the second surface 53 has a planar shape. The second surface 53 extend along the first direction D1. For example, the second surface 53 extends parallel to the first surface 52, and is perpendicular to the extending direction A. The second surface 53 faces the second inner surface 41f of the hole 40 along the extending direction A when the protrusion 50 enters the hole 40. For example, the plurality of surfaces 51 include a first inclined surface 54 located at a lower end of the first surface 52 and a second inclined surface 55 located at a lower end of the second surface 53. The first inclined surface 54 and the second inclined surface 55 are inclined to approach each other as the first inclined surface 54 and the second inclined surface 55 become spaced apart from the first surface 52 and the second surface 53.

Next, a method for removing the coating from the optical fiber core F in the coating remover 1 will be described. First, the optical fiber core F is set in the optical fiber holder H. Next, the holder holding portion 10 is brought closer to the main body portion 20, and the lid portion 25 of the main body portion 20 and the lid portion 12 of the holder holding portion 10 are opened. The optical fiber holder H is set on the holder placement portion 11 of the holder holding portion 10. A tip portion of the optical fiber core F that protrudes from the optical fiber holder H is disposed on the heater 29b across the first blade 27.

Next, the lid portion 12 of the holder holding portion 10 is closed, and the lid portion 25 of the main body portion 20 is closed. At this time, the protrusion 50 of the lid portion 25 enters the hole 40 of the optical fiber placement portion 24 of the main body portion 20. Accordingly, the movement of the lid portion 25 in the extending direction A relative to the optical fiber placement portion 24 is restricted. Furthermore, when the lid portion 25 is closed, the first blade 27 of the lid portion 25 comes into contact with the coating of the optical fiber core F placed on the first blade 27 of the optical fiber placement portion 24, and the first blade portion 27b and the second blade portion 28b cut into the coating.

When the lid portion 25 is closed, the heater power switch described above is turned on, and the heater 29b on which the tip portion of the optical fiber core F is placed is energized. The coating removal target portion of the optical fiber core F placed on the heater 29b is heated and softened by the heater 29b. For example, when the display portion 23c displays that the temperature of the optical fiber core F has reached the maximum temperature for removing the coating, the holder holding portion 10 and the main body portion 20 are each gripped, and the holder holding portion 10 is moved in the direction (forward) away from the main body portion 20. At this time, the coating heated and softened at a position closer to the tip of the optical fiber core F than the location of the cut in the optical fiber core F made by the first blade 27 and the second blade 28 is removed, and the glass fiber is exposed at the end portion of the optical fiber core F. A series of steps in the coating removal method are completed through the above-described steps.

Effects obtained from the coating remover 1 according to the present embodiment will be described. The coating remover 1 includes the optical fiber placement portion 24 on which the optical fiber core F is placed, and the lid portion 25 that is openable and closable relative to the optical fiber placement portion 24. The optical fiber placement portion 24 includes the first blade 27 that cuts into the coating of the optical fiber core F, and the lid portion 25 includes the second blade 28 facing the first blade 27 along the first direction D1 that is a closing direction. The optical fiber placement portion 24 has the hole 40 recessed in the first direction D1. The lid portion 25 has the protrusion 50 that enters the hole 40 of the optical fiber placement portion 24 when the first blade 27 comes into contact with the coating. The protrusion 50 of the lid portion 25 is defined by the plurality of surfaces 51. Among the plurality of surfaces 51, the first surface 52 that is a surface facing away from the first blade 27 and the second blade 28 extends along the first direction D1.

The first surface 52 extends along the first direction D1 that is a direction in which the second blade 28 of the lid portion 25 faces the first blade 27. When the second blade 28 comes into contact with the coating and the protrusion 50 enters the hole 40, the first surface 52 of the protrusion 50 which extends along the first direction D1 faces the surface 41 of the hole 40 along the extending direction A of the optical fiber core F. Since the first surface 52 of the protrusion 50 faces the surface 41 of the hole 40 along the extending direction A of the optical fiber core F, the misalignment of the second blade 28 in the extending direction A is prevented by the first surface 52 of the protrusion 50. Therefore, the position of the second blade 28 of the lid portion 25 in the extending direction A can be prevented from being shifted from the first blade 27 of the optical fiber placement portion 24.

As described above, among the plurality of surfaces 51, the second surface 53 facing away from the first surface 52 may extend along the first direction D1. In this case, when the second blade 28 comes into contact with the coating and the protrusion 50 enters the hole 40, the second surface 53 of the protrusion 50 which extends along the first direction D1 faces the surface 41 of the hole 40 along the extending direction A of the optical fiber core F. Since the misalignment of the second blade 28 in the extending direction A is prevented by the second surface 53 of the protrusion 50, the position of the second blade 28 of the lid portion 25 in the extending direction A can be prevented from being shifted from the first blade 27 of the optical fiber placement portion 24.

As described above, the optical fiber placement portion 24 may have the hole 40 recessed in the first direction D1, and the lid portion 25 may have the protrusion 50 that enters the hole 40. In this case, since the hole 40 is formed in the optical fiber placement portion 24 located below the lid portion 25, even when debris of the optical fiber core F enters the hole 40, the debris can be easily removed.

In the present embodiment, the hole 40 may be open in the third direction D3 that is a direction intersecting both the first direction D1 and the second direction D2. In this case, since the hole 40 of the optical fiber placement portion 24 is open in the third direction D3, debris of the optical fiber core F can be removed more easily.

In the present embodiment, the protrusion 50 of the lid portion 25 enters the hole 40 of the optical fiber placement portion 24 before the second blade 28 of the lid portion 25 comes into contact with the coating of the optical fiber core F placed on the optical fiber placement portion 24. Before the second blade 28 comes into contact with the coating, the protrusion 50 enters the hole 40. When the protrusion 50 enters the hole 40, the surface 51 of the protrusion 50 faces the surface 41 of the hole 40 along the extending direction A of the optical fiber core F. Since the surface 51 of the protrusion 50 faces the surface 41 of the hole 40 along the extending direction A of the optical fiber core F, the misalignment of the second blade 28 in the extending direction A is prevented by the surface 51 of the protrusion 50. Therefore, the position of the second blade 28 of the lid portion 25 in the extending direction A can be prevented from being shifted from the first blade 27 of the optical fiber placement portion 24.

The embodiment of the coating remover according to the present disclosure has been described above. However, the present invention is not limited to the embodiment described above. It will be easily understood by those skilled in the art that various modifications and changes can be made to the present invention within the scope of the concept described in the claims. For example, the shape, size, number, material, and disposition mode of each part of the coating remover can be changed as appropriate without departing from the scope of the concept.

For example, in the embodiment described above, the coating remover 1 in which the optical fiber placement portion 24 has the hole 40 and the lid portion 25 has the protrusion 50 has been described. However, a coating remover in which the optical fiber placement portion 24 has the protrusion 50 and the lid portion 25 has the hole 40 may be employed. In this case, the optical fiber placement portion 24 has the protrusion 50 protruding in the second direction D2, and the lid portion 25 has the hole 40 that the protrusion 50 enters when the second blade 28 comes into contact with the coating. The protrusion 50 of the optical fiber placement portion 24 enters the hole 40 of the lid portion 25 before the second blade 28 of the lid portion 25 comes into contact with the coating of the optical fiber core F placed on the optical fiber placement portion 24. Even with this coating remover, the same effects as those of the coating remover 1 described above are obtained.

In the embodiment described above, the coating remover 1 in which the cross-section of the protrusion 50 taken along a plane extending in both the extending direction A and the first direction D1 has a rectangular shape has been described. However, a coating remover in which the cross-section of the protrusion taken along a plane extending in both the extending direction A and the first direction D1 is not rectangular in shape may be employed. A coating remover including a protrusion in which one of the first surface 52 and the second surface 53 is inclined with respect to the first direction D1 may be employed. In such a manner, in the coating remover according to the present disclosure, the shape of the protrusion can be changed as appropriate. The same applies to the recess.

### REFERENCE SIGNS LIST

1: coating remover, 10: holder holding portion, 11: holder placement portion, 12: lid portion, 13: slide shaft, 14: hinge, 20: main body portion, 22: coating removal portion, 23: operation portion, 23b: switch, 23c: display portion, 24: optical fiber placement portion, 24b: side surface portion, 24c: top surface portion, 25: lid portion, 25b: side surface portion, 25c: top surface portion, 25d: inner surface portion, 26: hinge, 27: first blade, 27 b: first blade portion, 27 c: support portion, 28: second blade, 28b: second blade portion, 28c: support portion, 29: heating portion, 29b: heater, 40: hole, 41: surface, 41b: inclined surface, 41c: bottom surface, 41d: first inner surface, 41f: second inner surface, 42: protrusion accommodating portion, 43: extending portion, 45: opening, 50: protrusion, 51: surface, 51b: first inclined surface, 51c: second inclined surface, 51d: curved surface, 52: first surface, 53: second surface, 54: first inclined surface, 55: second inclined surface, A: extending direction, D1: first direction, D2: second direction, D3: third direction, F: optical fiber core, H: optical fiber holder.

What is claimed is:

1. A coating remover, comprising:
an optical fiber placement portion on which an optical fiber core including a coating is placed, and which includes a first blade that cuts into the coating; and
a lid portion openable and closable relative to the optical fiber placement portion and including a second blade that faces the first blade along a first direction, which is a closing direction, when the lid portion is closed onto the optical fiber placement portion,
wherein the optical fiber placement portion has a hole recessed in the first direction or a protrusion protruding in a second direction that is a direction opposite to the first direction,
the lid portion has a protrusion that enters the hole of the optical fiber placement portion when the second blade comes into contact with the coating or a hole that the protrusion of the optical fiber placement portion enters when the second blade comes into contact with the coating,
the protrusion of the optical fiber placement portion or the protrusion of the lid portion is formed by a plurality of surfaces, and
among the plurality of surfaces, a first surface that is a surface facing away from the first blade and the second blade extends along the first direction.

2. The coating remover according to claim 1,
wherein, among the plurality of surfaces, a second surface facing away from the first surface extends along the first direction.

3. The coating remover according to claim 1,
wherein the optical fiber placement portion has a hole recessed in the first direction, and
the lid portion has a protrusion that enters the hole.

4. The coating remover according to claim 3,
wherein the hole is open in a third direction that is a direction intersecting both the first direction and the second direction.

5. A coating remover, comprising:
an optical fiber placement portion on which an optical fiber core including a coating is placed, and which includes a first blade that cuts into the coating; and
a lid portion openable and closable relative to the optical fiber placement portion and including a second blade that faces the first blade along a first direction, which is a closing direction, when the lid portion is closed onto the optical fiber placement portion,
wherein the optical fiber placement portion has a hole recessed in the first direction or a protrusion protruding in a second direction that is a direction opposite to the first direction,
the lid portion has a protrusion that enters the hole of the optical fiber placement portion or a hole that the protrusion of the optical fiber placement portion enters, and
the protrusion of the optical fiber placement portion or the protrusion of the lid portion enters the hole of the lid portion or the hole of the optical fiber placement portion before the second blade of the lid portion comes into contact with the coating of the optical fiber core placed on the optical fiber placement portion.
